(19) United States
(12) Patent Application Publication
(10) Pub. No.: US 2004/0253049 A1
(43) Pub. Date: Dec. 16, 2004

(54) Tubular link with integral crimp socket joint and optional secondary side crimp

(76) Inventors: Lee A. Bissonnette, Clarkston, MI (US); George C. Thompson, Rochester, NY (US); Neil H. Ambrose, Batavia, NY (US); Paul J. Klingler, Spencerport, NY (US)

Correspondence Address: Andrew R. Basile, Young & Basile, P.C., Suite 824, 3001 West Big Beaver Road, Troy, MI, 48084, US

(21) Appl. No.: 10/457,997

(22) Filed: Jun. 10, 2003

(51) Int. Cl. F16D 1/12

(52) U.S. Cl. 403/128

(57) ABSTRACT

An apparatus and method associated with a ball socket joint in a windshield wiper drive module system of a motor vehicle includes a body having a ball socket portion and a tenon portion extending outwardly from the ball socket portion. The ball socket portion of the body defines at least a portion of a ball socket aperture, either an open-socket configuration or closed-socket configuration. A shaped surface, defined by at least a portion of the peripheral surface of the tenon portion of the body, is provided for dramatically increasing static load capability of a crimped joint to be formed in cooperation with the tenon portion of the body. The shaped surface can include a plurality of ridges extending across at least a substantial portion of a width of the tenon portion of the body, and/or a plurality of straight, parallel ridges spaced longitudinally from one another along a centerline axis of the tenon portion of the body, and/or a plurality of angled ridges extending spaced longitudinally from one another along the tenon portion of the body. A hollow tube can receive the tenon portion of the body in each of two opposite open ends. A crimped joint can be formed adjacent each end of the tube for connecting the body to the tube to define a coupling link for use in a windshield wiper drive module system for a motor vehicle.

### FIELD OF THE INVENTION

The present invention relates to a ball socket member, and more particularly to a ball socket member for forming an integral crimp socket joint with a tubular link, such as those used in a windshield wiper drive module system, with optional secondary side crimp.

### BACKGROUND OF THE INVENTION

Previously, the linkages used on windshield wiper drive modules included many bends and curves embedded into the structure. These linkages typically have been formed of a U-shaped channel linkage body in order to provide the drive module system design with flexibility at a minimum cost. However, the majority of current windshield wiper drive modules use straight non-bent links. The heavy-duty U-shaped channel links are now viewed as adding extra weight to the module system and have excess load capacity that is no longer being used in the current drive module systems.

Current windshield wiper drive module links are assembled in one of two ways. In both final assembly methods, a “raw” preformed link structure is required. The preformed link structure is currently stamped from strip stock steel and formed into a U-shaped channel cross section. The U-shaped channel link material can have a variety of material thicknesses and can be formed with a variety of U-shaped channel depths. The material thickness and depth variations are needed to stiffen the U-shaped channel link structure. While the link has a compressive load capacity, its torsional load capacity can be affected by the material thickness and U-shaped channel depth. Arm head casting assemblies are solid assemblies in the axial and radial directions. With many bends in the linkage, the U-shaped channel design is easy to manufacture. Often multi-stage progressive dies can be used to stamped out the appropriate form and stiffness required for the particular application.

Once the “raw” link has been formed, two options for attaching sockets are currently used. In a low load application, a simply light weight and light strength ball socket is snapped into the linkages mating circular aperture cutouts formed in the linkage. While the force in-line loads applied from ball studs onto the sockets may be low, the U-shaped channel linkage still needs to be fairly heavy to resist any torsional loading caused by the linkage bent or curved design. These heavy U-shaped channel linkages are still in use today, even though the links are more often straight and have less and less torsional loads.

The second method for attaching the ball sockets to the “raw” link is by overmolding the ball sockets directly onto the linkage. This method of assembly is used when the in-line forces from the ball studs are large and the center-to-center distance between the sockets are critical for the modular systems output control capability. This method of manufacturing is more costly than simply snapping in sockets into a linkage mating circular aperture, since new overmolding dies are required to be made for each change in linkage length and/or “raw” link material thickness and U-shaped channel shape change.

### SUMMARY OF THE INVENTION

The tubular link ball socket joint according to the present invention replaces the U-shaped channel link currently used in windshield wiper drive module systems. The tube can be formed of any suitable material having sufficient strength and thickness to support the anticipated loads for the particular application, and is simply cut to the desired length for the particular application. No additional processing is required in order to form the link. The tubing ends are then crimped or crushed over or around the tenon portion of the ball socket member. The crushing and/or crimping is performed in a plane with the ball socket parting line or perpendicular to the ball socket center position. The tube according to the present invention can have a slight bend or curve added if desired for the particular application. However, the maximum bend or curve angle is a function of the overall length of the tube link and the expected force loads for the particular application.

A ball socket according to the present invention includes a tenon portion that can be crimped onto both ends of a tubular section of the link assembly. The ball sockets at the opposite ends of the tubular section can be parallel to each other, or can be rotated at any desired angle, such as an obtuse angle with respect to one another. The crimp form on the tenon portion of the ball socket is preferably flat and in a plane with the ball socket parting line.

The crimp shape on the ball socket is shaped so that the applied force load is distributed over the entire length of the tenon portion. The tenon portion of the ball socket can include shaped means for increasing a static load capability of the crimped joint. The shaped means can include parallel ridges extending across a width of the tenon portion of the ball socket, and/or herringbone pattern of interwoven ridges extending across the width of the tenon portion of the ball socket. The herringbone pattern of interwoven ridges can be in the form of Y-shaped ridges and/or V-shaped ridges and/or X-shaped ridges extending across a width of the tenon portion of the ball socket.

When crimped to a longitudinal end of a tube that has been cut to the desired length, the force load is transferred through the tube to the tenon crimped joint. In the parallel ridge crimp configuration, approximately 80% or more of the load is held by the first crimp indentation. For lightly load systems, with sufficiently strong material cross sections in the first crimp indentation, this configuration is adequate to support the required force load. However, if the load exceeds this low load, the material cross section cannot support this load and the tenon could potentially fail unexpectedly.

In many instances, there is insufficient space available to increase the tenon cross section to increase the force load capability of the parallel ridge configuration of the crimped joint. To avoid this consequence, a herringbone pattern of interwoven ridges formed according to the present invention is provided to increase the maximum crimp load for the crimped joint. The herringbone pattern of interwoven ridges crimp form distributes the force load more evenly across the tenon portion of the crimped joint. In one configuration, the herringbone pattern of interwoven ridges can be shaped in a Y type pattern with Y centers not crossing at the center line axis of the tenon. If a V type pattern is desired, the V point end should be positioned offset transversely from the center line axis of the tenon portion of the ball socket. If the V point ended on the tenon center line, the force would be further concentrated, and the first V point would concentrate an even higher load than the straight parallel ridge crimped joint configuration. The Y points can be offset from the center line of the tenon portion axis of the ball socket. The Y points are preferably positioned in approximately 40% to 60% distance from the center line and are positioned to be in opposite construction distance on opposite sides of the center line axis of the tenon portion of the ball socket. The Y type crimp pattern is sometimes referred to as a tractor tread or Chevron shape.

There are two possible directions for the Y type crimp pattern to run. In the first case, the Y type crimp configuration has an open face toward the ball socket shell opening. In the second case, the Y type ridge configuration has an open face toward the tube portion of the link assembly. While both possible directions distribute the force load through the tenon portion of the ball socket structure, the Y type with the open face toward the tube portion of the link assembly has a greater resistance to fatigue and joint loosening.

The Y type joint crimp angle can be dependent on the sustained or cyclical load retention required. The easiest angle to start with is 45°. Based on the thickness of the tenon in crimped joint ridges, the angle can be varied until the force load is fully distributed across the tenon section. In this way, the maximum load capability of the crimped joint can be used with the minimum amount of space and material required.

The Y type crimp configuration, while easy to mold is more difficult to machine. For machining, the Y type crimp sections can be extended to a X type pattern. Again, it is desirable for the center point of the X type to avoid being positioned in the center of the tenon portion of the ball socket member.

In comparing the two primary crimp joints, each one has advantages. The horizontal tenon crimp configuration has advantages over the Y type tenon crimp in the area of tool wear and maintenance. A straight, flat, perpendicular die form is easier to maintain and is subject to less effects of die wear and fixture change issues over time. The Y type tenon crimp has a greater propensity for die tool wear as the individual crimp compression sections are generally smaller and machined at an angle. Fixture changes over time can have a greater impact on the integrity of the crimped joint.

Another issue consistent with the crimping of the tenon in a vertical direction is the side-to-side play that can occur over time due to cyclical loading of the tenon portion of the crimped tube joint. The joint can also loosen from material creep or fatigue. To lessen these effects, the tenon crimp configuration according to the present invention employs an additional optional side crimp methodology. The optional side crimp or material stretching and/or pinching is secondary to the primary vertical crimp operation. However, the optional side crimp adds additional load resistance and minimizes the effects of material creep or fatigue. The optional secondary crimp can be performed at the same time as the primary crimp, or in a post primary crimp die set. At the -same time with a stepped die set system is the preferred methodology.

The optional secondary crimp can add to the strength and longevity of the crimped joint configuration. While the optional secondary crimp is not always necessary, the secondary crimp is the preferred configuration. The optional secondary side crimp is formed tightly around the vertical or curved side faces of the tenon portion of the ball socket member. By compressing the primary horizontal surface first, all of the tube material is pressed flat or formed to the shape of the tenon hold form to conform with the shaped means for increasing static load capability of the crimped joint. The remaining tube material is then finish formed around the sides of the tenon portion of the ball socket member, and pressed into a final shape securing the tenon portion of the ball socket to the tube for strength and fatigue resistance.

In static load cases, the dialing in of the primary and secondary crimping showed a 30% to 40% improvement in the static load capability of the crimped joint. This improvement allows the design failure mode of the system according to the present invention to be the opening of the crimped joint and the growth of the link center line distance causing a visible warning to a user of the system that system wear out is in progress.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of a windshield wiper drive module system according to the present invention;

FIG. 2 is a perspective view of a ball socket member with shaped means for increasing static load capability of a crimped joint according to the present invention;

FIG. 3 is a side elevational view of the ball socket member illustrated in FIG. 2;

FIG. 4 is a bottom view of the ball socket member illustrated in FIGS. 2 and 3;

FIG. 5 is a perspective view of a ball socket member with shaped means for increasing static load capability of a crimped joint according to the present invention;

FIG. 6 is a side elevational view of the ball socket member illustrated in FIG. 5;

FIG. 7 is a bottom view of the ball socket element illustrated in FIGS. 5 and 6;

FIG. 8 is a side elevational view of a link assembly according to the present invention with the ball socket members aligned with one another;

FIG. 9 is an end view of the link assembly illustrated in FIG. 8;

FIG. 10 is a bottom view of the link assembly illustrated in FIGS. 8 and 9;

FIG. 11 is a side elevational view of a link assembly according to the present invention with the ball socket members offset at an angle with respect to one another;

FIG. 12 is an end view of the link assembly illustrated in FIG. 11; and

FIG. 13 is a side elevational view of the link assembly illustrated in FIGS. 11 and 12.

### DETAILED DESCRIPTION OF THE PREFERRED EMBODIMENT

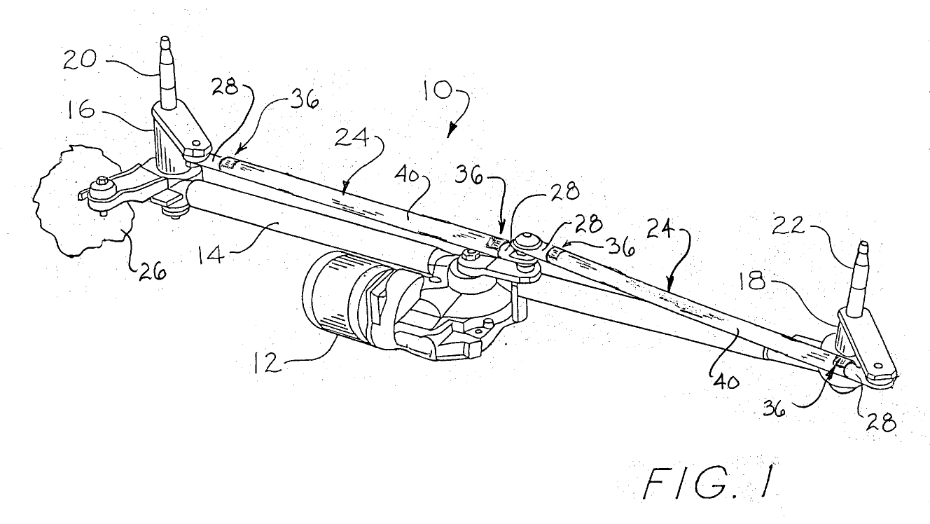

A windshield wiper drive module system 10 for a motor vehicle is illustrated in perspective view in FIG. 1. The drive module system 10 can include a windshield wiper drive motor 12 premounted thereon. A support member 14 of the drive module system 10 carries bearing elements 16, 18 at opposite ends for rotatably supporting corresponding wiper shafts 20, 22 in an axially secured manner. Coupling links 24 extend between the windshield wiper drive motor 12 and a corresponding crank arm connected to each of the wiper shafts 20, 22. The coupling links 24 transfer rotational motion from the crank arm of the wiper drive motor 12 into synchronized oscillatory movement of the wiper shafts 20, 22. The drive module system 10 according to the present invention is connectable to a support wall 26 associated with a body of the motor vehicle. The drive module system 10 according to the present invention permits the rotational axes of the wiper shafts 20, 22 to be properly positioned with respect to a windshield to be wiped associated with the vehicle body.

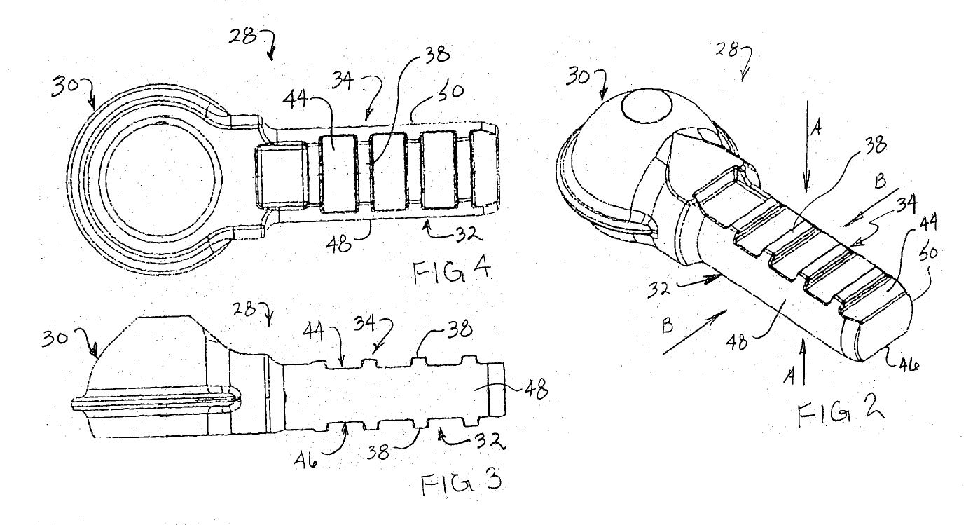

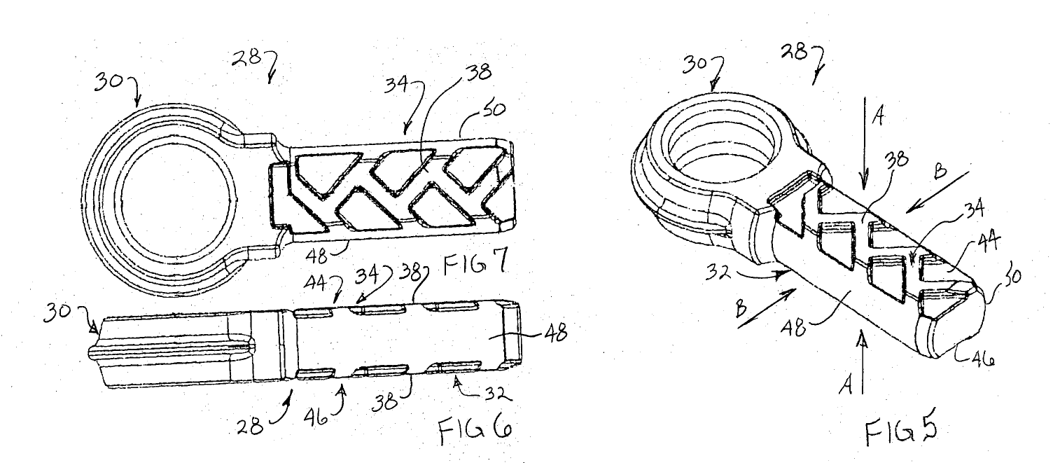

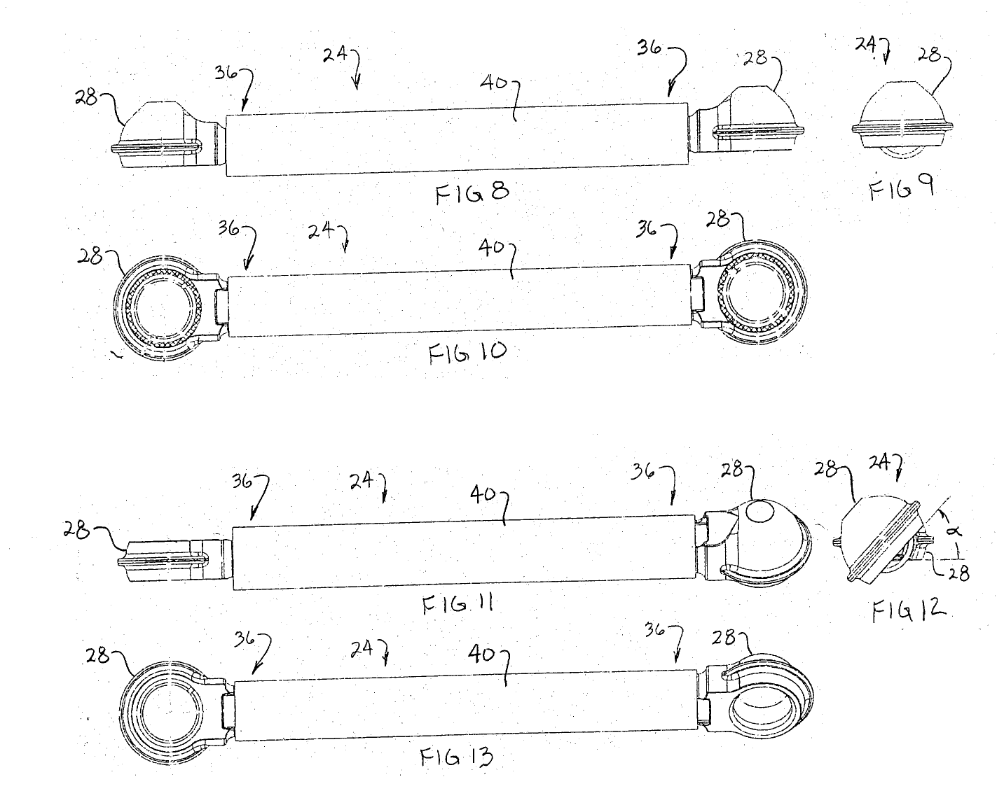

Referring now to FIGS. 1-13, a ball socket member 28 includes a ball socket portion 30 and a tenon portion 32. The ball socket portion 30 can be formed in either a closed socket configuration as illustrated in FIGS. 2-4 or an open socket configuration as illustrated in FIGS. 5-7. In either case, closed socket or open socket configuration, the ball socket member 28 is generically referred to as having a ball socket portion 30 and a tenon portion 32. The tenon portion 32 of the ball socket member 28 includes shaped means 34 for increasing static load capability of a crimped joint 36.

Referring now to FIGS. 2-4, the shaped means 34 can include a plurality of straight, parallel ridges 38 spaced longitudinally from one another along the center line axis of the tenon portion 32 and extending across at least a substantial portion of the width of the tenon portion 32 of the ball socket member 28. When a crimped joint 36 is formed between an end of tube 40 and the ball socket member 28 as best seen in FIGS. 8-13, approximately 80% or more of the load is held by the first crimp indentation. The shaped means 34 formed on the tenon portion 32 of the ball socket member 28 as illustrated in FIGS. 2-4 is adequate for supporting the required force load of lightly loaded systems provided sufficiently strong material cross sections are provided for the particular application.

Referring now to FIGS. 5-7, if expected force loads are higher, the shaped means 34 can be formed as a plurality of interwoven ridges 42 defining a herringbone pattern, sometimes referred to herein as a Y type pattern, X type pattern, or V type pattern. The interwoven ridges 42 distribute the force load more evenly across the tenon portion 32 of the ball socket member 28. In the preferred configuration, the angled point of the center of the Y, X, or V patterns do not coincide with the center line axis of the tenon portion 32 of the ball socket member 28. In the preferred configuration, the angled point or centers of the Y pattern, X pattern, or V pattern are offset transversely from the center line axis of the tenon portion 32 by a distance in a range between approximately 40% to approximately 60% inclusive of the total distance from the center line axis of the tenon portion 32 to the outer sidewall of the tenon portion 32 of the ball socket member 28. In the preferred configuration, the angled points or centers of the Y pattern, X pattern, or V pattern are positioned on opposite sides of the center line axis of the tenon portion 32 at opposite distances from the center line axis. In other words, one side of the tenon portion includes a herringbone pattern which is a mirror image of the opposite side of the tenon portion 32 of the ball socket member 28.

The herringbone pattern of the plurality of interwoven ridges 42 can be formed extending in one of two directions. In the first direction, the herringbone pattern of the plurality of the interwoven ridges 42 have an open face toward the ball socket portion 30 of the ball socket member 28 (not shown). In the second direction, the herringbone pattern of the plurality of interwoven ridges 42 have an open face extending toward an outer end of the tenon portion 32 of the ball socket member 28 as best seen in FIGS. 5-7. While both directions distribute the force load through the tenon portion 32 of the ball socket member 28, the herringbone pattern with the plurality of interwoven ridges 42 having an open face toward the outer end of the tenon portion 32 has a greater resistance to fatigue and joint loosening. The herringbone pattern of the plurality of interwoven ridges 42 can be formed at any desired angle depending on the sustained or cyclic load retention required for the particular application. By way of example and not limitation, the illustrated herringbone pattern of the plurality of interwoven ridges 42 illustrated in FIGS. 5-7 is angled at approximately 45° with respect to the center line axis of the tenon portion and are positioned at approximately 90° with respect to one another. This angular orientation can be varied until the force load is fully distributed across the tenon section as desired for the particular application. In this way, the maximum load capacity of the crimped joint 36 can be used with the minimum amount of space and material required.

Referring now to FIGS. 8-13, a coupling link 24 is illustrated having a ball socket member 28, either open socket or closed socket configuration, connected with a crimped joint 36 at opposite open ends of tube 40. The ball socket member 28 at one or both ends of the tube 40 can include shaped means 34 with either straight ridges 38 or interwoven ridges 42 as desired for the particular application. It should be recognized that a coupling link 24 can include ball socket members 28 having closed sockets at both ends, open sockets at both ends, or one closed socket at one end and one open socket at an opposite end of the tube 40. It should further be recognized that the ball socket member 28 can include a tenon portion 32 having shaped means 34 with straight ridges 38 at both ends of the tube 40, or interwoven ridges 42 at both ends of the tube 40, or straight ridges 38 at one end of the tube 40 and interwoven ridges 42 at an opposite end of the tube 40. As best seen by comparing FIGS. 8-10 with FIGS. 11-13, the ball socket member 28 can be connected through crimped joint 36 with tube 40 in a parallel relationship to each other as illustrated in FIGS. 8-10, or rotated at an angle with respect to one another as illustrated in FIGS. 11-13.

In the preferred configuration, the crimped joint 36 is formed with primary and secondary crimping operations. The primary crimping operation occurs in a first direction generally normal to the opposite sides 44, 46 of the tenon portion 32 of the ball socket member 28, i.e. generally in the direction indicated by the arrow labeled A in FIGS. 2 and 5. The secondary crimping operation occurs in a second direction generally perpendicular to the direction illustrated by arrow A and is designated by arrow B in FIGS. 2 and 5. The secondary crimping operation adds load resistance to the crimped joint 36 and minimizes the effects of material creep or fatigue which can result in excess side-to-side play in the crimped joint 36. The secondary crimping operation can be performed at the same time as the primary crimping operation, or can be performed in a post primary crimp die set. The secondary crimping operation adds strength and longevity to the crimped joint 36. The secondary crimping operation is formed tightly around the peripheral faces 48, 50 of the tenon portion 32 extending between the sides 44, 46. By performing the primary crimping operation first, all of the tube material is pressed flat or formed to the shape of the tenon portion 32 including the shaped means 34. The remaining tube material is then finish formed during the secondary crimping operation around the peripheral faces of the tenon and pressed into a final shape securing the tenon portion 32 of the ball socket member 28 to the tube 40 for strength and fatigue resistance. In static load cases, the preferred configuration of the crimped joint 36 including primary and secondary crimping operations, showed approximately 30% to approximately 40% improvement in the static load capability of the crimped joint 36.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An apparatus associated with a ball socket joint in a windshield wiper drive module system of a motor vehicle, comprising:
a body have a ball socket portion and a tenon portion extending outwardly from the ball socket portion, the ball socket portion defining at least a portion of a ball socket aperture; and
shaped means, defined by at least a portion of the peripheral surface of the tenon portion of the body, for increasing static load capability of a crimped joint to be formed in cooperation with the tenon portion of the body.

2. The apparatus of claim 1, wherein the shaped means further comprises:
a plurality of ridges extending across at least a substantial portion of a width of the tenon portion of the body.

3. The apparatus of claim 1, wherein the shaped means further comprises:
a plural of straight, parallel ridges spaced longitudinally from one another along a centerline axis of the tenon portion of the body.

4. The apparatus of claim 3, wherein each parallel ridge has a smaller dimension in a direction extending along a centerline axis of the tenon portion of the body than a corresponding dimension in the direction extending along the centerline axis of the tenon portion of the body of a recess positioned between two adjacent parallel ridges.

5. The apparatus of claim 1, wherein the shaped means further comprises:
a plurality of angled ridges defining a herringbone pattern.

6. The apparatus of claim 5, wherein the herringbone pattern extends longitudinally along the tenon portion with an angular opening facing an outer end of the tenon portion of the body.

7. The apparatus of claim 5, wherein the herringbone pattern defines a plurality of angled points, each angled point spaced transversely from a centerline axis of the tenon portion of the body.

8. The apparatus of claim 1, wherein the shaped means further comprises:
a plurality of angled ridges extending spaced longitudinally from one another along the tenon portion of the body.

9. The apparatus of claim 8, wherein the angled ridges extend at an angle of approximately 90° with respect to one another and are positioned at an angle of approximately 45° with respect to a centerline axis of the tenon portion of the body.

10. The apparatus of claim 8, wherein the angled ridges define points facing toward the ball socket portion of the body and define angular openings facing an outer end of the tenon portion of the body.

11. The apparatus of claim 10, wherein the points are positioned offset transversely with respect to a centerline axis of the tenon portion of the body.

12. The apparatus of claim 11, wherein the points are offset transversely by a distance in a range between approximately 40% and approximately 60% inclusive of the total distance from the centerline axis of the tenon portion of the body to a sidewall of the tenon portion of the body.

13. The apparatus of claim 1 further comprising:
a hollow tube for receiving the tenon portion of the body in each of two opposite open ends; and
a crimped joint adjacent each end of the tube for connecting the body to the tube.

14. The apparatus of claim 13, wherein the crimped joint includes a primary crimped portion subjected to a crimping force in a first direction generally perpendicular to opposite sidewalls of the tenon portion of the body.

15. The apparatus of claim 14, wherein the crimped joint includes a secondary crimped portion subjected to a crimping force in a second direction generally perpendicular to the first direction causing deformation of the tube toward a peripheral surface of the tenon extending between the opposite sidewalls of the tenon portion of the body.

16. The apparatus of claim 14, wherein the secondary crimped portion improves a static load capacity of the crimped joint in a range between approximately 30% and approximately 40% inclusive over a static load capacity of the primary crimped portion.

17. The apparatus of claim 13, wherein the tube with the body attached at each end defines a coupling link for a windshield wiper drive module system of a motor vehicle.

18. The apparatus of claim 17 further comprising:
a windshield wiper drive shaft; and
a drive motor having an output shaft connected to a crank arm, wherein the coupling link connects to the crank arm through the body at one end and connects to the windshield wiper drive shaft through the body at the opposite end.

19. The apparatus of claim 13, wherein the crimped joints attaching the body at each end of the tube positions the bodies in a parallel relationship to one another.

20. The apparatus of claim 13, wherein the crimped joints attaching the body at each end of the tube positions the bodies in an offset angular orientation with respect to one another.

21. The apparatus of claim 20, wherein the bodies are offset angularly about a longitudinal axis of the tube with respect to one another.

22. The apparatus of claim 1, wherein the ball socket portion of the body defines at least one of a closed socket and an open socket.

23. A method associated with a ball socket joint in a windshield wiper drive module system of a motor vehicle comprising the steps of:
providing a body having a ball socket portion and a tenon portion extending outwardly from the ball socket portion, the ball socket portion defining at least a portion of a ball socket aperture; and
forming shaped means defined by at least a portion of the peripheral surface of the tenon portion of the body for increasing static load capability of a crimped joint to be formed in cooperation with the tenon portion of the body.

24. The method of claim 23, wherein the forming step further comprises the step of:
forming a plurality of ridges extending across at least a substantial portion of a width of the tenon portion of the body to define the shaped means.

25. The method of claim 23, wherein the forming step further comprises the step of:
forming a plurality of straight parallel ridges spaced longitudinally from one another along a centerline axis of the tenon portion of the body to define the shaped means.

26. The method of claim 25, wherein the forming step further comprises the step of:
forming each parallel ridge with a smaller dimension in a direction extending along a centerline axis of the tenon portion of the body than a corresponding dimension in the direction extending along the centerline axis of the tenon portion of the body of a recess positioned between two adjacent parallel ridges.

27. The method of claim 23, wherein the forming step further comprises the step of:
forming a plurality of angled ridges defining a herringbone pattern for the shaped means.

28. The method of claim 27, wherein forming step further comprises the step of:
forming the herringbone pattern extending longitudinally along the tenon portion with an angular opening facing an outer end of the tenon portion of the body.

29. The method of claim 27, wherein the forming step further comprises the step of:
forming the herringbone pattern to define a plurality of angled points, each angled point spaced transversely from a centerline axis of the tenon portion of the body.

30. The method of claim 23, wherein the forming step further comprises the step of:
forming a plurality of angled ridges extending spaced longitudinally from one another along the tenon portion of the body.

31. The method of claim 30, wherein forming step further comprises the step of:
forming the angled ridges extending at an angle of approximately 90° with respect to one another and positioned at an angle of approximately 45° with respect to a centerline axis of the tenon portion of the body.

32. The method of claim 30, wherein the forming step further comprises the step of:
forming the angled ridges to define points facing toward the ball socket portion of the body and to define angular openings facing an outer end of the tenon portion of the body.

33. The method of claim 32, wherein the forming step further comprises the step of:
forming the points to be positioned offset transversely with respect to a centerline axis of the tenon portion of the body.

34. The method of claim 33, wherein forming step further comprises the step of:
forming the points to be offset transversely by a distance in a range between approximately 40% and approximately 60% inclusive of the total distance from the centerline axis of the tenon portion of the body to a sidewall of the tenon portion of the body.

35. The method of claim 23 further comprising the steps of:
receiving the tenon portion of the body in each of two opposite open ends of a hollow tube; and
connecting the body to the tube with a crimped joint adjacent each end of the tube.

36. The method of claim 35, wherein the connecting step further comprises the step of:
forming the crimped joint with a primary crimped portion subjected to a crimping force in a first direction generally perpendicular to opposite sidewalls of the tenon portion of the body.

37. The method of claim 36, wherein the connecting step further comprises the step of:
forming the crimped joint with a secondary crimped portion subjected to a crimping force in a second direction generally perpendicular to the first direction causing deformation of the tube toward a peripheral surface of the tenon extending between the opposite sidewalls of the tenon portion of the body.

38. The method of claim 36, wherein the connecting step further comprises the step of:
improving a static load capacity of the crimped joint with the secondary crimped portion in a range between approximately 30% and approximately 40% inclusive over a static load capacity of the primary crimped portion alone.

39. The method of claim 35, wherein the connecting step further comprises the step of:
forming a coupling link for a windshield wiper drive module system of a motor vehicle with the tube having the body attached at each end.

40. The method of claim 39 further comprising the steps of:
providing a windshield wiper drive shaft; and
providing a drive motor having an output shaft connected to a crank arm; and
connecting the coupling link to the crank arm through the body at one end and connecting the coupling link to the windshield wiper drive shaft through the body at the opposite end.

41. The method of claim 35, wherein the connecting step further comprises the step of:
positioning the body at each end of the tube in a parallel relationship to one another with the crimped joints.

42. The method of claim 35, wherein the connecting step further comprises the step of:
positioning the body at each end of the tube in an offset angular orientation with respect to one another with the crimped joints.

43. The method of claim 42, wherein the connecting step further comprises the step of:
angularly offsetting the bodies about a longitudinal axis of the tube with respect to one another.

44. The method of claim 23, wherein the ball socket portion provided with the body defines at least one of a closed socket and an open socket.

45. An apparatus manufactured according to the method of claim 23 comprising:
a body having a ball socket portion and a tenon portion extending outwardly from the ball socket portion, the ball socket portion defining at least a portion of a ball socket aperture; and
shaped means, defined by at least a portion of the peripheral surface of the tenon portion of the body, for increasing static load capability of a crimped joint to be formed in cooperation with the tenon portion of the body.
